(19) United States
(12) Patent Application Publication
(10) Pub. No.: US 2013/0218473 A1
(43) Pub. Date: Aug. 22, 2013

(54) FREQUENCY SHIFT DETECTOR

(71) Applicants: Chua-Chin Wang, Kaohsiung City (TW); Chia-Hao Hsu, Kaohsiung City (TW); I-Yu Huang, Kaohsiung City (TW); Yun-Chi Chen, Kaohsiung City (TW); Yue-Da Tsai, Kaohsiung City (TW); Ming-Chih Lee, Kaohsiung City (TW)

(72) Inventors: Chua-Chin Wang, Kaohsiung City (TW); Chia-Hao Hsu, Kaohsiung City (TW); I-Yu Huang, Kaohsiung City (TW); Yun-Chi Chen, Kaohsiung City (TW); Yue-Da Tsai, Kaohsiung City (TW); Ming-Chih Lee, Kaohsiung City (TW)

(73) Assignee: NATIONAL SUN YAT-SEN UNIVERSITY, Kaohsiung City (TW)

(21) Appl. No.: 13/592,010

(22) Filed: Aug. 22, 2012

(30) Foreign Application Priority Data
Feb. 22, 2012 (TW) 101105845

(51) Int. Cl. G06F 19/00

(52) U.S. Cl. 702/19; 702/23

(57) ABSTRACT

A frequency shift detector includes a digital control unit, a digital/analog converter, a reagent concentration detecting circuit and a frequency difference generator, wherein the digital control unit includes a control circuit and a direct digital frequency synthesizer electrically connected with the control circuit, and the control circuit comprises a reset terminal and a pulse input terminal. The digital control unit proceeds with accurate concentration detection for various samples borne on the reagent concentration detecting circuit.

### FIELD OF THE INVENTION

The present invention is generally related to a frequency shift detector, which particularly relates to the frequency shift detector with accurate immunoglobulin concentration inspection from a sample by digital operation.

### BACKGROUND OF THE INVENTION

ELISA (Enzyme-linked immunosorbent assay) analysis is one of the primary detection methods for protein concentration. The procedure in ELISA analysis is to make the plate coated with antigen of the sample. Next, some hydro-phobic sites of the plate are filled with gelatin. Then, adding a primary antibody corresponded to the antigen and a secondary antibody corresponded to the first antibody. Eventually, a colored product with relative concentration is produced through mentioned procedures. The volume of specific antigen can be determined via color intensity of the colored product so that a protein concentration of the sample is detectable. However, in ELISA analysis procedure, a sample must proceed with heating process, which results in reduction of solubility, denatured globulin and loss of antigenicity. Accordingly, mentioned heating process appears to substantially compromise the accuracy of protein concentration.

### SUMMARY

The primary object of the present invention is to provide a frequency shift detector with accurate protein concentration detection from a sample. The frequency shift detector includes a digital control unit, a digital/analog converter, a reagent concentration detecting circuit and a frequency difference generator, wherein the digital control unit includes a control circuit and a direct digital frequency synthesizer electrically connected with the control circuit, and the control circuit comprises a reset terminal and a pulse input terminal. The direct digital frequency synthesizer of the frequency shift detector outputs an accumulating signal. The digital/analog converter electrically connects with the direct digital frequency synthesizer of the digital control unit and receives the accumulating signal so as to output a sine wave signal. The reagent concentration detecting circuit electrically connects with the digital/analog converter and receives the sine wave signal so as to output a first storage signal and a second storage signal. The frequency difference generator electrically connects with the reagent concentration detecting circuit and receives the first storage signal and the second storage signal so as to generate a frequency difference value. The protein concentration of the specific sample is obtainable by comparing the frequency difference value with a look up table. In the present invention, by means of the digital control unit composed of the control circuit and the direct digital frequency synthesizer, the output frequency ranges produced by digital operation are provided to proceed with accurate concentration detection for various bio-medical samples borne on the reagent concentration detecting circuit. Besides, the present invention is capable of integrating the frequency shift detector into a chip therefore possessing features of small volume, low cost and low power consumption.

### DESCRIPTION OF THE DRAWINGS

FIG. 1 is a circuit diagram illustrating a frequency shift detector in accordance with a preferred embodiment of the present invention.

FIG. 2 is a control flow chart illustrating a frequency shift detector in accordance with a preferred embodiment of the present invention.

### DETAILED DESCRIPTION OF THE INVENTION

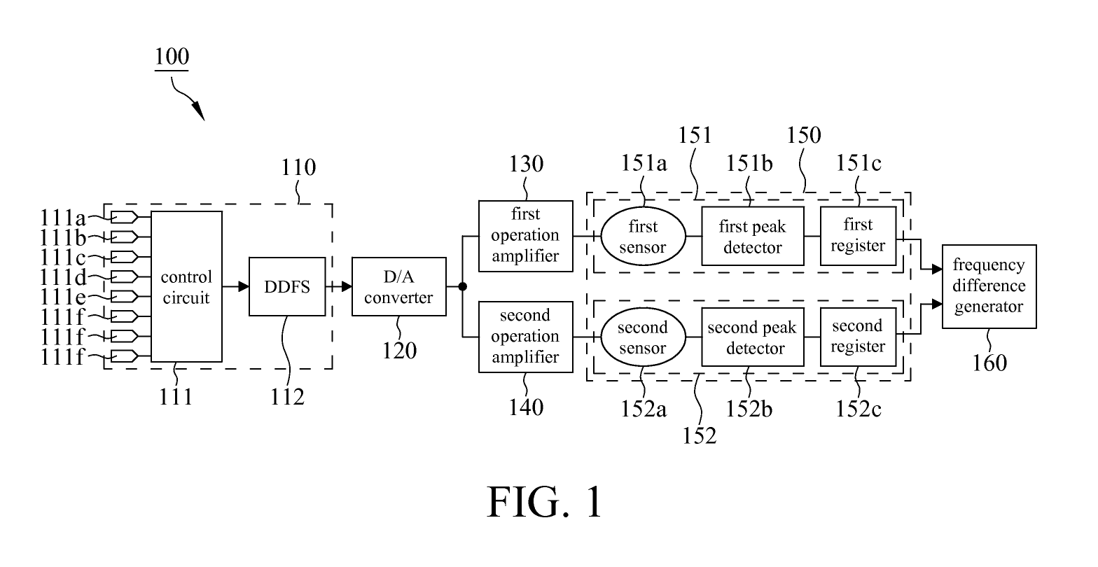

With reference to FIG. 1, a frequency shift detector 100 in accordance with an embodiment of the present invention utilizes for detecting a protein concentration of a sample accurately, the frequency shift detector 100 includes a digital control unit 110, a digital/analog converter 120, a reagent concentration detecting circuit 150 and a frequency difference generator 160. The digital control unit 110 includes a control circuit 111 and a direct digital frequency synthesizer (DDFS) 112 electrically connected with the control circuit 111, the control circuit 111 comprises a reset terminal 111a and a pulse input terminal 111b, wherein the reset terminal 111a enables to receive a reset signal for resetting the frequency shift detector 100, and the pulse input terminal 111b receives a pulse signal for driving the control circuit 111 and the direct digital frequency synthesizer 112 into operation. The control circuit 111 outputs a digital signal to the direct digital frequency synthesizer 112, wherein the digital signal is a 32 bits long signal. The direct digital frequency synthesizer 112 receives the digital signal, retrieves 8 bits from the digital signal and outputs an accumulating signal, wherein the accumulating signal is an 8 bits long signal. Since the frequency shift detector 100 can be integrated into a chip, bits retrieved from the direct digital frequency synthesizer 112 effectively lower the chip layout area. The digital/analog converter 120 electrically connects with the direct digital frequency synthesizer 112 of the digital control unit 110 and receives the accumulating signal so as to output a sine wave signal. The reagent concentration detecting circuit 150 electrically connects with the digital/analog converter 120 and receives the sine wave signal so as to output a first storage signal and a second storage signal. The frequency difference generator 160 electrically connects with the reagent concentration detecting circuit 150 and receives the first storage signal and the second storage signal so as to generate a frequency difference value Δƒ. In this embodiment, by comparing the frequency difference value Δƒ with a look up table, the protein concentration of the sample is obtainable. Besides, the frequency difference generator 160 is a subtractor.

With reference to FIG. 1, in this embodiment, the control circuit 111 of the digital control unit 110 further comprises a load terminal 111c, a control terminal 111d, an external pin 111e and a plurality of test pins 111f. The load terminal 111c, the control terminal 111d and the external pin 111e determine whether a digital value or a predetermined value at a specific scanning frequency from external circuits is offered to the digital control unit 110. The test pins 111f are utilized to test the control circuit 111 and check if the control circuit 111 operates normally. The reagent concentration detecting circuit 150 includes a first detecting circuit 151 and a second detecting circuit 152, wherein the first detecting circuit 151 comprises a first sensor 151a, a first peak detector 151b electrically connected with the first sensor 151a and a first register 151c electrically connected with the first peak detector 151b, and the second detecting circuit 152 comprises a second sensor 152a, a second peak detector 152b electrically connected with the second sensor 152a and a second register 152c electrically connected with the second peak detector 152b. The sample borne on the first sensor 151a of the reagent concentration detecting circuit 150 is a protein solvent, and the second sensor 152a is a comparison set corresponded to the first sensor 151a. In this embodiment, the frequency shift detector 100 further includes a first operation amplifier 130 and a second operation amplifier 140, one end of the first operation amplifier 130 and one end of the second operation amplifier 140 electrically connect with the digital/analog converter 120, wherein another end of the first operation amplifier 130 electrically connects with the first sensor 151a of the first detecting circuit 151, and another end of the second operation amplifier 140 connects with the second sensor 152a of the second detecting circuit 152. Since the operation amplifier acts as a unity gain buffer, the sine wave signal outputted from the digital/analog converter 120 is transferred to the first sensor 151a and the second sensor 152a separately through the first operation amplifier 130 and the second operation amplifier 140 so that the load effect of the frequency shift detector 100 produced by the first sensor 151a and the second sensor 152a can be effectively reduced. In addition, the control circuit 111 electrically connects with the first register 151c and the second register 152c. When the first peak detector 151b receives a voltage level higher than the voltage level that is previously accessed in the first register 151c, the first peak detector 151b outputs an enable signal to make the first register 151c receive and storage the accumulating value representing the center frequency from the digital control unit 110. Further, the first register 151c outputs the first storage signal to the frequency difference generator 160.

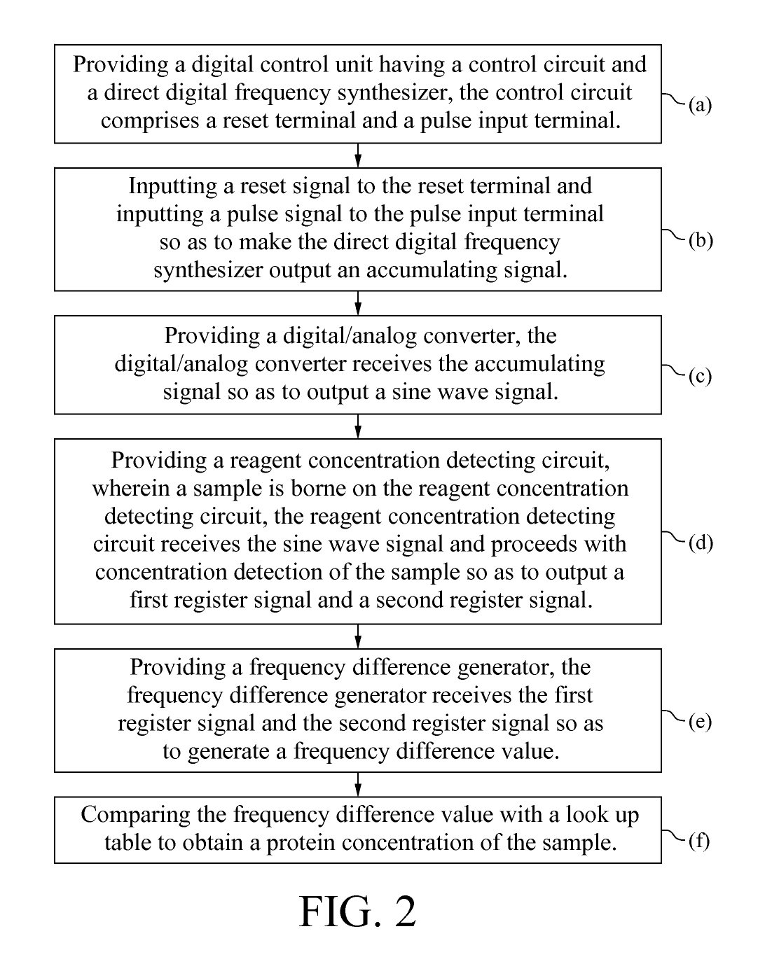

With reference to FIGS. 1 and 2, a control method of the frequency shift detector includes the steps described as followed. First, referring to step (a) in FIG. 2, providing a digital control unit 110 having a control circuit 111 and a direct digital frequency synthesizer 112, the control circuit 111 comprises a reset terminal 111a and a pulse input signal 111b; referring to step (b) in FIG. 2, inputting a reset signal to the reset terminal 111a for resetting the frequency shift detector 100 and inputting a pulse signal to the pulse input terminal 111b for driving the control circuit 111 and the direct digital frequency synthesizer 112 into operation so as to enable the control circuit 111 to output a 32 bits digital signal to the direct digital frequency synthesizer 112 and make the direct digital frequency synthesizer 112 output an 8 bits accumulating signal; referring to step (c) in FIG. 2, providing a digital/analog converter 120, wherein the digital/analog converter 120 receives the accumulating signal and outputs a sine wave signal; referring to step (d) in FIG. 2, providing a reagent concentration detecting circuit 150, wherein a sample is borne on the reagent concentration detecting circuit 150, the reagent concentration detecting circuit 150 receives the sine wave signal and proceeds with concentration detection of the sample so as to output a first storage signal and a second storage signal; eventually, referring to step (e) in FIG. 2, providing a frequency difference generator 160, wherein the frequency difference generator 160 receives the first storage signal and the second storage signal so as to generate a frequency difference value Δƒ. In this embodiment, the control method of the frequency shift detector 100 further includes a step of providing a first operation amplifier 130 and a second operation amplifier 140, one end of the first operation amplifier 130 and one end of the second operation amplifier 140 electrically connect with the digital/analog converter 120, wherein another end of the first operation amplifier 130 electrically connects with the first sensor 151a of the first detecting circuit 151, and another end of the second operation amplifier 140 electrically connects with the second sensor 152a of the second detecting circuit 152, wherein the step is interposed between the step of providing the digital/analog converter 120 and the step of providing the reagent concentration detecting circuit 150. Furthermore, referring to step (f) in FIG. 2, the control method further includes a step of comparing the frequency difference value Δƒ with a look up table to obtain a protein concentration of the sample after the step of providing the frequency difference generator 160.

By means of the digital control unit 110 composed of the control circuit 111 and the direct digital frequency synthesizer 112, the output frequency ranges produced by digital operation are provided to proceed with accurate concentration detection for various bio-medical samples borne on the reagent concentration detecting circuit 150. Besides, the present invention is capable of integrating the frequency shift detector 100 into a chip therefore possessing features of small volume, low cost and low power consumption.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A frequency shift detector including:
a digital control unit having a control circuit and a direct digital frequency synthesizer electrically connected with the control circuit, the control circuit comprises a reset terminal and a pulse input terminal, wherein the pulse input terminal receives a pulse signal, and the direct digital frequency synthesizer outputs an accumulating signal;
a digital/analog converter electrically connected with the direct digital frequency synthesizer of the digital control unit, the digital/analog converter receives the accumulating signal and outputs a sine wave signal;
a reagent concentration detecting circuit electrically connected with the digital/analog converter, the reagent concentration detecting circuit receives the sine wave signal so as to output a first storage signal and a second storage signal; and
a frequency difference generator electrically connected with the reagent concentration detecting circuit, the frequency difference generator receives the first storage signal and the second storage signal to generate a frequency difference value.

2. The frequency shift detector in accordance with claim 1, wherein the reagent concentration detecting circuit includes a first detecting circuit and a second detecting circuit, the first detecting circuit comprises a first sensor and a first peak detector electrically connected with the first sensor, the second detecting circuit comprises a second sensor and a second peak detector electrically connected with the second sensor.

3. The frequency shift detector in accordance with claim 2, wherein the first detecting circuit of the reagent concentration detecting circuit further comprises a first register electrically connected with the first peak detector, and the second detecting circuit comprises a second register electrically connected with the second peak detector.

4. The frequency shift detector in accordance with claim 3, wherein the control circuit of the digital control unit electrically connects with the first register and the second register of the reagent concentration detecting circuit.

5. The frequency shift detector in accordance with claim 1 further comprises a first operation amplifier and a second operation amplifier, one end of the first operation amplifier and one end of the second operation amplifier electrically connect with the digital/analog converter, wherein another end of the first operation amplifier and another end of the second operation amplifier electrically connect with the reagent concentration detecting circuit.

6. The frequency shift detector in accordance with claim 2 further comprises a first operation amplifier and a second operation amplifier, one end of the first operation amplifier and one end of the second operation amplifier electrically connect with the digital/analog converter, wherein another end of the first operation amplifier electrically connects with the first sensor of the first detecting circuit, and another end of the second operation amplifier electrically connects with the second sensor of the second detecting circuit.

7. A control method of a frequency shift detector including:
providing a digital control unit having a control circuit and a direct digital frequency synthesizer, the control circuit comprises a reset terminal and a pulse input signal;
inputting a reset signal to the reset terminal and inputting a pulse signal to the pulse input terminal so as to make the direct digital frequency synthesizer output an accumulating signal;
providing a digital/analog converter, wherein the digital/analog converter receives the accumulating signal and outputs a sine wave signal;
providing a reagent concentration detecting circuit, wherein a sample is borne on the reagent concentration detecting circuit, the reagent concentration detecting circuit receives the sine wave signal and proceeds with concentration detection of the sample so as to output a first storage signal and a second storage signal; and
providing a frequency difference generator, wherein the frequency difference generator receives the first storage signal and the second storage signal so as to generate a frequency difference value.

8. The control method of a frequency shift detector in accordance with claim 7, wherein the reagent concentration detecting circuit includes a first detecting circuit and a second detecting circuit, the first detecting circuit comprises a first sensor and a first peak detector electrically connected with the first sensor, the second detecting circuit comprises a second sensor and a second peak detector electrically connected with the second sensor.

9. The control method of a frequency shift detector in accordance with claim 8, wherein the first detecting circuit of the reagent concentration detecting circuit further comprises a first register electrically connected with the first peak detector, and the second detecting circuit further comprises a second register electrically connected with the second peak detector.

10. The control method of a frequency shift detector in accordance with claim 8 further includes a step of providing a first operation amplifier and a second operation amplifier, one end of the first operation amplifier and one end of the second operation amplifier electrically connect with the digital/analog converter, wherein another end of the first operation amplifier electrically connects with the first sensor of the first detecting circuit, and another end of the second operation amplifier electrically connects with the second sensor of the second detecting circuit interposed between the step of providing the digital/analog converter and the step of providing the reagent concentration detecting circuit.

11. The control method of a frequency shift detector in accordance with claim 9, wherein the control circuit of the digital control unit electrically connects with the first register and the second register of the reagent concentration detecting circuit.

12. The control method of a frequency shift detector in accordance with claim 7 further includes a step of comparing the frequency difference value with a look up table to obtain a protein concentration of the sample after the step of providing a frequency difference generator.
